(19) United States
(12) Patent Application Publication
(10) Pub. No.: US 2011/0086981 A1
(43) Pub. Date: Apr. 14, 2011

(54) MANUFACTURING METHOD FOR SURFACE-MODIFIED RUBBER MOLDED BODY

(75) Inventors: Makoto Ashiura, Hiratsuka (JP); Tetsuji Kawazura, Hiratsuka (JP)

(73) Assignee: The Yokohama Rubber Co., Ltd.

(21) Appl. No.: 12/751,661

(22) Filed: Mar. 31, 2010

(30) Foreign Application Priority Data
Apr. 2, 2009 (JP) 2009-090542

(51) Int. Cl. C08C 19/28

(52) U.S. Cl. 525/105

(57) ABSTRACT

A manufacturing method for a surface-modified rubber molded body is described. An uncross-linked rubber molded body is made of a rubber composition containing an organic peroxide and a modified butyl rubber composition (A) containing a modified butyl rubber (1) where a compound (a) with a stable nitroxide free radical in the molecule at ambient temperature in the presence of oxygen, a radical initiator (b), and a radical polymeric monomer (c) with at least difunctionality are reacted with butyl rubber, or a modified butyl rubber composition (B) where the monomer (c) is added to a modified butyl rubber (2) where the compound (a) and the radical initiator (b) are reacted with butyl rubber. A siloxane compound having a (meth)acryloyl group is applied onto the surface of the uncross-linked rubber molded body. The uncross-linked rubber molded body is then heat-treated.

### PRIORITY CLAIM

This application is based upon and claims the benefit of priority from Japanese Patent Application No. 2009-090542, filed Apr. 2, 2009, the entire contents of which are incorporated herein by reference.

### TECHNICAL FIELD

The present invention relates to a manufacturing method for a surface-modified rubber molded body, and in particular, relates to a manufacturing method for a surface-modified rubber molded body with enhanced slip properties and release properties to various rubber products during vulcanization, and with greatly enhanced sustainability of release performance.

### BACKGROUND OF THE INVENTION

Generally, vulcanization molding of pneumatic tires is performed by vulcanizing while pressing an outer surface of an unvulcanized tire to an inner surface of a vulcanizing mold. The unvulcanized tire is placed in the vulcanizing mold, high-temperature and high-pressure steam or the like is pressure injected into a rubber pouch-shaped bladder inserted into a cavity of the unvulcanized tire, and the unvulcanized tire is expanded. The bladder is formed from a butyl rubber, and therefore there is tackiness between the bladder and an inner liner made from halogenated butyl rubber, or the like, disposed on an inner circumferential surface of the unvulcanized tire. Therefore, slip properties, with respect to the inner liner, are inferior when the bladder is expanded at the start of vulcanization. Additionally, release properties are inferior when the bladder is shrunk and removed from the pneumatic tire after vulcanization. There are thus problems with damage and the like to the inner liner.

To solve these problems, various types of release agents such as silicon and the like have been applied to an outer surface of the bladder or the inner circumferential surface of the unvulcanized tire. However, the release agent must be frequently applied each time vulcanization molding is performed because a release effect of the release agent is not sustained for a long period of time. Therefore, the effects on workability and the working environment are a problem.

Previous methods have proposed forming a lubrication layer with release properties made from two layers, a silicon rubber layer and a silicon resin layer, on the outer surface of the bladder. However, with this method, the outer surface of the resin cross-linked bladder is surface-treated. This causes a reactivity of the silicone rubber with butyl rubber molecules to be low. As a result of this, and because vulcanization molding is repeatedly performed, there are problems that release properties and slip properties are low and that sustainability cannot be sufficiently achieved.

### SUMMARY OF THE INVENTION

### Problem to be Solved by the Invention

An object of the present invention is to provide a manufacturing method for a surface-modified rubber molded body having enhanced release properties and slip properties toward various types of rubber products during vulcanization, and having greatly enhanced sustainability of release performance.

### Means for Solving the Problem

A manufacturing method for a surface-modified rubber molded body of the present invention that achieves the aforementioned object includes the steps of:
forming an uncross-linked rubber molded body made of a rubber composition containing an organic peroxide and
a modified butyl rubber composition (A) containing modified butyl rubber (1) wherein a compound (a) with a stable nitroxide free radical in the molecule at ambient temperature in the presence of oxygen, a radical initiator (b), and a radical polymeric monomer (c) with at least difunctionality are reacted with butyl rubber, or a modified butyl rubber composition (B) where the monomer (c) is added to a modified butyl rubber (2) where the compound (a) and the radical initiator (b) are reacted with a butyl rubber;
applying a siloxane compound having a (meth)acryloyl group onto a surface of the uncross-linked rubber molded body; and
heat-treating.

The siloxane compound having a (meth)acryloyl group is preferably at least one type selected from organopolysiloxane compounds represented by the following formulas (1), (2), or (3):

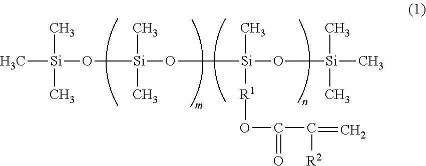

(wherein, R¹ is a divalent polyalkylene glycol group, a poly(oxyalkylene) group, an alkyl group, or an alkylene group; R² is hydrogen or a methyl group; and m and n are integers selected such that a number average molecular weight is from 1,000 to 20,000, and a ratio m:n is from 98:2 to 90:10.)

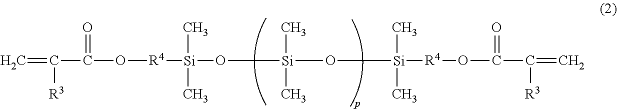

(wherein, R³ is hydrogen or a methyl group, R⁴ is an alkyl group or an alkylene group, and p is an integer selected such that a number average molecular weight is from 100 to 20,000.)

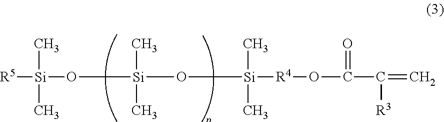

(wherein, R³ is hydrogen or a methyl group, R⁴ and R⁵ independently are alkyl groups or alkylene groups, and p is an integer selected such that a number average molecular weight is from 100 to 20,000.)

The radical polymeric monomer (c) with at least difunctionality can be simultaneously added to or reacted with a radical polymeric monomer (d) having an alkoxysilyl group.

The surface-modified rubber molded body obtained by the manufacturing method of the present invention can be preferably used as a bladder in a vulcanization molder for a pneumatic tire.

### EFFECT OF THE INVENTION

According to the manufacturing method for a surface-modified rubber molded body of the present invention an uncross-linked rubber molded body made from the rubber composition containing the organic peroxide and the modified butyl rubber composition (A) or (B) is formed; the siloxane compound having a (meth)acryloyl group is applied to the surface of the uncross-linked rubber molded body; and the same is heat-treated. Thus, when the uncross-linked rubber molded body made from modified butyl rubber composition (A) or (B) is cross-linked by the organic peroxide, the siloxane compound having a (meth) acryloyl group will react with the modified butyl rubber composition. Through this process, the siloxane compound having a (meth) acryloyl group will firmly bond to the surface of the rubber molded body, excellent release properties and slip properties will be provided, and sustainability of release performance will be greatly enhanced.

### BEST MODE FOR CARRYING OUT THE INVENTION

Both modified butyl rubber compositions (A) and (B) used in the manufacturing method of the present invention can be cross-linked by an organic peroxide. Therefore, when an uncross-linked rubber molded body formed from the modified butyl rubber composition (A) or (B) is cross-linked by a peroxide, a siloxane compound having a (meth)acryloyl group can react with the modified butyl rubber, allowing for surface modification of the rubber molded body.

Generally, a bladder that is attached to a vulcanization molder for a pneumatic tire is formed by resin cross-linking butyl rubber. Therefore even if resin cross-linking is performed after applying the siloxane compound on a surface of the uncross-linked rubber molded body, the siloxane compound will not react with the butyl rubber molecules. Therefore, there is little difference in release performance compared to a case where the siloxane compound is applied to a cross-linked rubber molded body.

With the present invention, peroxide cross-linking of the uncross-linked modified butyl rubber molded body and reacting with the siloxane compound having a (meth)acryloyl group are performed simultaneously. The siloxane compound is thus firmly bonded to the surface of the cross-linked rubber molded body, imparting it with excellent release properties and slip properties, and greatly enhancing sustainability of release performance.

The modified butyl rubber composition (A) is made from modified butyl rubber (1) made by reacting a compound (a) with a stable nitroxide free radical in a molecule at ambient temperature in the presence of oxygen (hereinafter referred to as “compound (a)”), a radical initiator (b), and a radical polymeric monomer (c) with at least difunctionality (hereinafter referred to also as “monomer (c)”). While the manufacturing method of the modified butyl rubber (1) is not particularly limited, methods such as the following are preferable.

First, a modified butyl rubber (2), in which the compound (a) is grafted with butyl rubber, is obtained by reacting the compound (a) and the radical initiator (b) with butyl rubber.

A peroxide crosslinkable modified butyl rubber (1) can be obtained by reacting the monomer (c) with the modified butyl rubber (2).

Furthermore, the modified butyl rubber composition (B) is made from a composition where the monomer (c) is added to the modified butyl rubber (2), which is made by reacting the compound (a) and the radical initiator (b). With the modified butyl rubber composition (B), when the unvulcanized rubber molded body formed using a rubber composition containing the modified butyl rubber (2) and the monomer (c) is heat-treated, a reaction between the modified butyl rubber (2) and the monomer (c) occurs at the same time as the peroxide cross-linking.

Examples of the compound (a) having a stable nitroxide free radical in the molecule at ambient temperature in the presence of oxygen used in the present invention include 2,2,6,6-tetramethyl-1-piperidinyloxy (hereinafter referred to as “TEMPO”) described by the following formula (4); oxo-2,2,6,6-tetramethyl-1-piperidinyloxy described by the following formula (5); and the like. Furthermore, a compound with a substituent at a position 4 of the TEMPO described by the following formulas (6) through (11) can also be used as the compound (a).

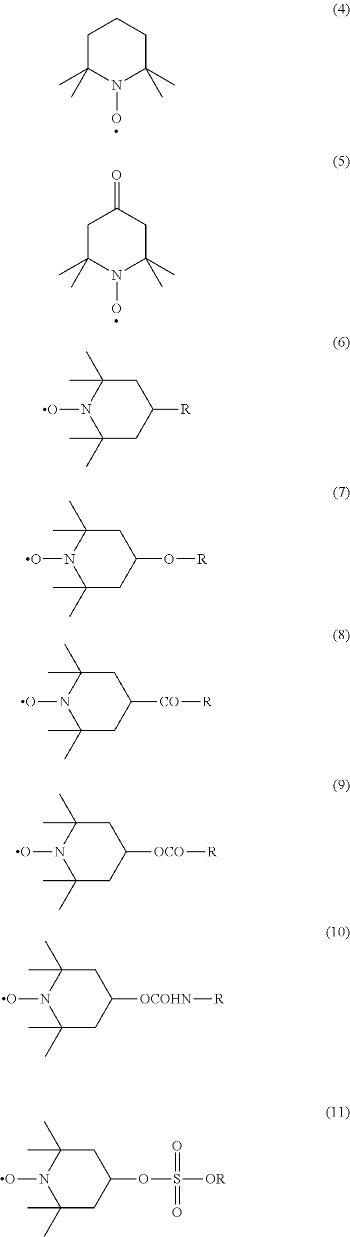

(in formulas (6) through (11), R is a functional group having between 1 and 30 carbon atoms selected from an alkyl group, alkylene group, aryl group, allyl group, vinyl group, carboxyl group, a group containing a carbonyl group, ester group, epoxy group, isocyanate group, hydroxy group, thiol group, thiirane group, amino group, amide group, imide group, nitro group, nitrile group, thiocyan group, silyl group, alkoxysilyl group, or an organic group containing these functional groups.)

Herein, examples of groups containing a carbonyl group include residues of cyclic anhydrides such as succinate anhydride, maleic anhydride, glutarate anhydride, phthalate anhydride, and the like. Furthermore, in the formula (6), R can also be a halogen such as chlorine, bromine, or the like.

Examples of the compound (a) described by the formula (6) include 4-methyl TEMPO, 4-ethyl TEMPO, 4-phenyl TEMPO, 4-chloro TEMPO, 4-hydroxy TEMPO, 4-amino TEMPO, 4-carboxyl TEMPO, 4-isocyanate TEMPO, and the like.

Examples of the compound (a) described by the formula (7) include 4-methoxy TEMPO, 4-ethoxy TEMPO, 4-phenoxy TEMPO, 4-TEMPO-glycidyl ether, 4-TEMPO-thioglycidyl ether, and the like.

Examples of the compound (a) described by the formula (8) include 4-methylcarbonyl TEMPO, 4-ethylcarbonyl TEMPO, 4-benzoyl TEMPO, and the like.

Examples of the compound described by the formula (9) include 4-acetoxy TEMPO, 4-ethoxycarbonyl TEMPO, 4-methacrylate TEMPO, 4-benzoyloxy TEMPO, and the like.

Examples of the compound (a) described by the formula (10) include 4-(N-methylcarbamoyloxy) TEMPO, 4-(N-ethylcarbamoyloxy) TEMPO, 4-(N-phenylcarbamoyloxy) TEMPO, and the like.

Examples of the compound (a) described by the formula (11) include methyl(4-TEMPO)sulfate, ethyl(4-TEMPO)sulfate, phenyl(4-TEMPO)sulfate, and the like.

Furthermore, examples of the compound (a) include compounds of 2,2,5,5-tetramethyl-1-pyrrolidinyloxy (hereinafter referred to as “PROXYL”) with a substituent at a third position as described in the following formula (12); and compounds of 2,2,5,5-tetramethyl-3-pyrroline-1-oxy (hereinafter referred to as “PRYXYL”) with a substituent at a third position as described in the following formula (13).

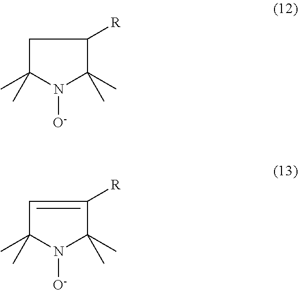

(in the formulas (12) and (13), R is a functional group having between 1 and 30 carbon atoms selected from an alkyl group, aryl group, allyl group, vinyl group, alkoxy group, carboxyl group, a group containing a carbonyl group, ester group, epoxy group, glycidyl group, isocyanate group, hydroxy group, thiol group, thiirane group, thioglycidyl group, amino group, amide group, imide group, carbamoyl group, nitro group, nitrile group, thiocyan group, silyl group, alkoxysilyl group, and organic groups containing these functional groups.)

Examples of the compound (a) described in the formula (12) include 3-amino-PROXYL, 3-hydroxy-PROXYL, 3-isocyanate-PROXYL, 3-carboxyl-PROXYL, 3-PROXYL-glycidyl ether, 3-PROXYL-thioglycidyl ether, 3-carbamoyl-PROXYL, and the like.

Examples of the compound (a) represented by the formula (13) include 3-amino-PRYXYL, 3-hydroxy-PRYXYL, 3-isocyanate-PRYXYL, 3-carboxyl-PRYXYL, 3-PRYXYL-glycidyl ether, 3-PRYXYL-thioglycidyl ether, 3-carbamoyl-PRYXYL, and the like.

Other examples of the compound (a) include the following.

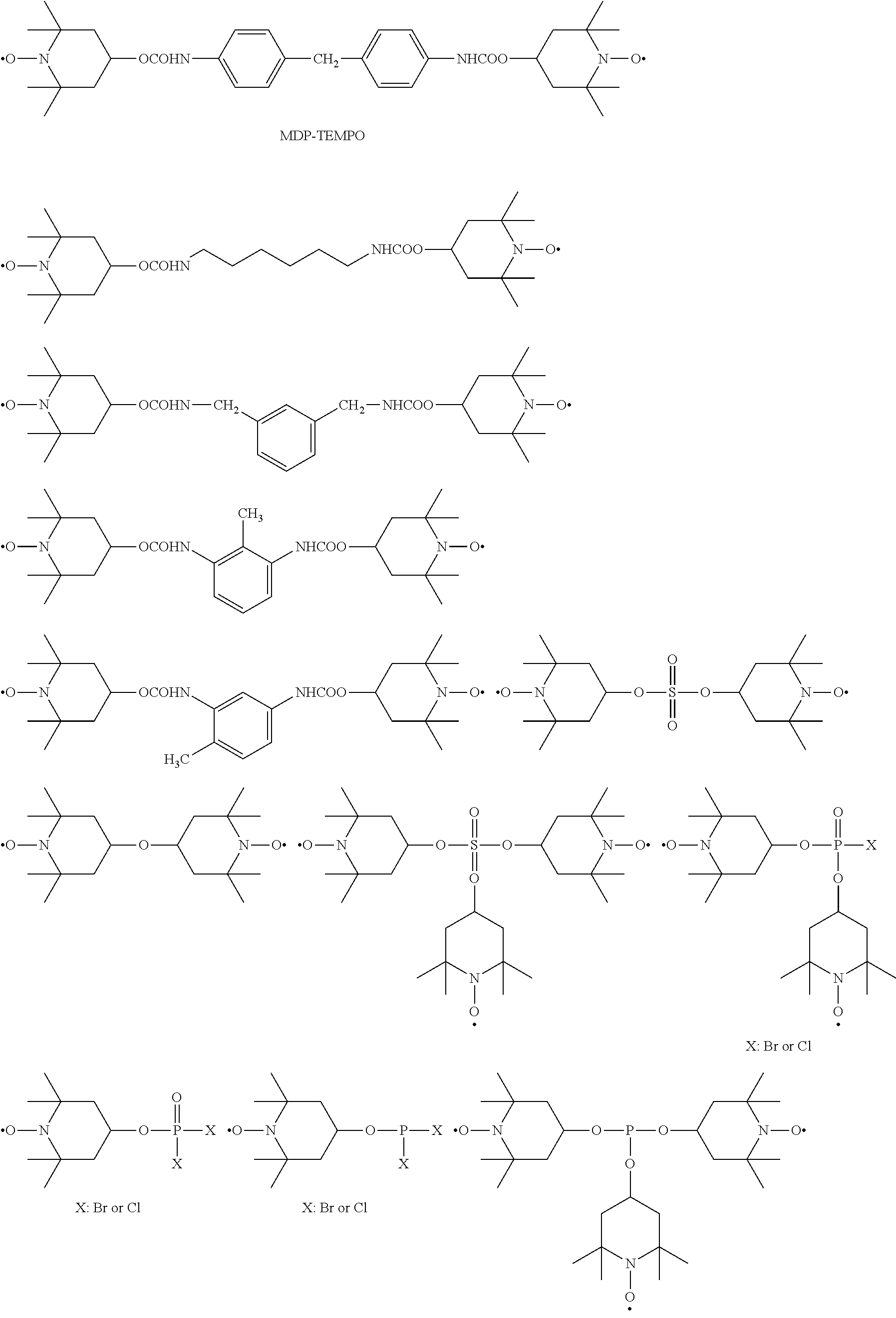

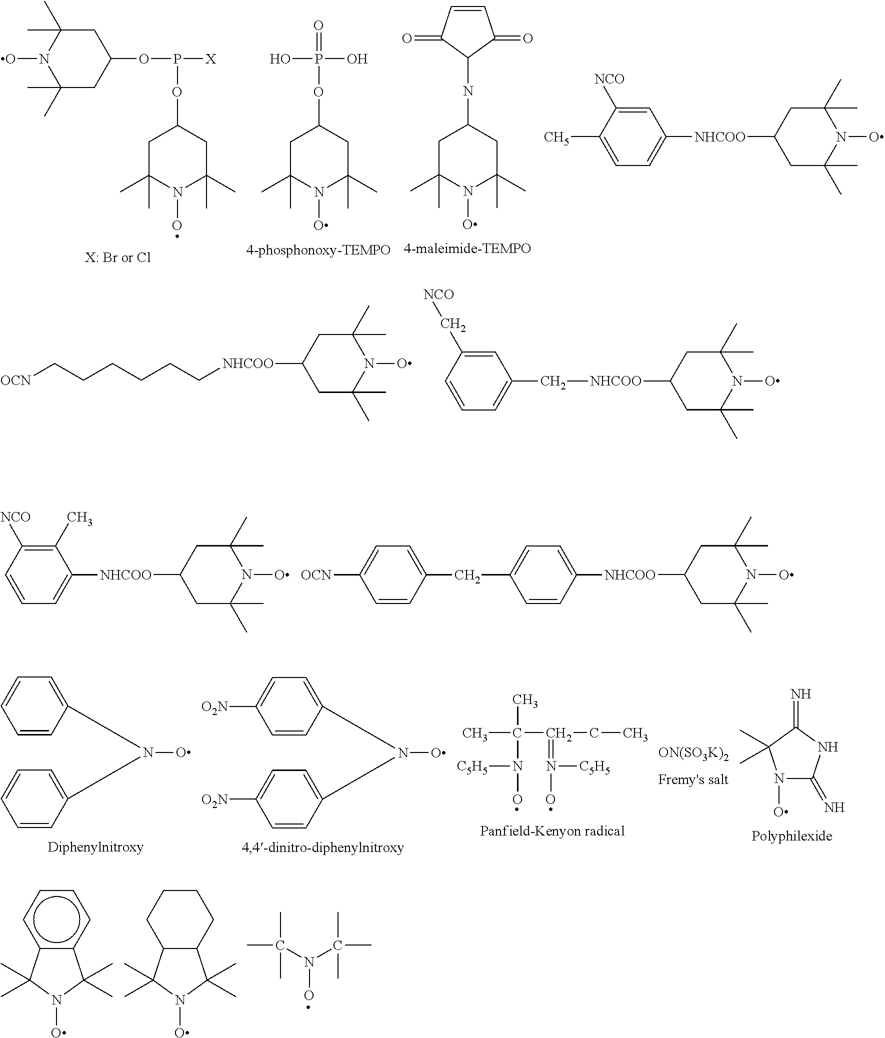

An added amount of the compound (a) used in the present invention is not particularly limited, but is preferably from 0.001 to 0.5 mol, and more preferably from 0.005 to 0.1 mol, per 100 g of the butyl rubber. If an added amount of the compound (a) is too small, there is a possibility that a degree of modification to the butyl rubber will be too small. Conversely, if the added amount is too large, there is a possibility that the peroxide cross-linking will not take place.

With the present invention, the compound (a) can be introduced to a molecular chain of the butyl rubber by adding the radical initiator (b). The radical initiator (b) can be any radical initiator, such as benzoyl peroxide; t-butylperoxybenzoate; dicumyl peroxide; t-butylcumyl peroxide; di-t-butyl peroxide; 2,5-dimethyl-2,5-di-t-butylperoxyhexane; 2,5-dimethyl-2,5-di-t-butylperoxy-3-hexene; 2,4-dichloro-benzoyl peroxide; di-t-butylperoxy-di-isopropyl benzene; 1,1-bis(t-butylperoxy)-3,3,5-trimethyl-cyclohexane; n-butyl-4,4-bis(t-butylperoxy)valerate; 2,2-bis(t-butylperoxy)butane; diisobutyl peroxide; cumylperoxyneodecanate; di-n-propylperoxydicarbonate; diisopropylperoxydicarbonate; di-sec-butylperoxydicarbonate; 1,1,3,3-tetramethylbutylperoxyneodecanate; di(4-t-butylcyclohexyl)peroxydicarbonate; 1-cyclohexyl-1-methylethylperoxyneodecanate; di(2-ethoxyethyl)peroxydicarbonate; di(2-ethoxyhexyl)peroxydicarbonate; t-hexylperoxyneodecanate; dimethoxybutylperoxydicarbonate; t-butylperoxyneodecanate; t-hexylperoxypipalate; t-butylperoxypipalate; di(3,5,5-trimethylhexanoyl)peroxide; di-n-octanoylperoxide; dilauroylperoxide; distearoylperoxide; 1,1,3,3-tetramethylbutylperoxy-2-ethylhexanoate; disuccinic acid peroxide; 2,5-dimethyl-2,5-di(2-ethylhexanoylperoxy)hexane; t-hexylperoxy-2-ethylhexanoate; di(4-methylbenzoyl)peroxide; t-butylperoxy-2-ethylhexanoate; a mixture of di(3-methylbenzoyl)peroxide, benzoyl(3-methylbenzoyl)peroxide, and dibenzoylperoxide; dibenzoylperoxide; t-butylperoxyisobutyrate; and the like.

A radical initiator capable of decomposing at low temperature due to an action of a redox catalyst can also be used. Typical examples of such a radical initiator include dibenzoyl peroxide; paramethane hydroperoxide; diisopropylbenzene hydroperoxide; 1,1,3,3-tetramethylbutyl hydroperoxide; cumene hydroperoxide; t-butyl hydroperoxide; and the like.

Other examples the radical initiator include azo-type radical initiators such as azodicarbonamide; azobisisobutyronitrile; 2,2′-azobis-(2-amidinopropane)dihydrochloride; dimethyl 2,2′-azobis(isobutyrate); azobiscyanovaleric acid; 1,1′-azobis-(2,4-dimethylvaleronitrile); azobismethylbutyronitrile; 2,2′-azobis-(4-methoxy-2,4-dimethylvaleronitrile); and the like.

By adding the radical initiator (b) to a reaction system (blended system or catalyst system), carbon radicals can be generated in the butyl rubber, and the modified butyl rubber can be obtained by reacting the compound (a) having stable free radicals with these carbon radicals.

An added amount of the radical initiator (b) used in the present invention is not particularly limited, but is preferably from 0.001 to 0.5 mol, and more preferably from 0.005 to 0.2 mol, per 100 g of the butyl rubber. If the amount of the radical initiator (b) added is too low, there is a possibility that the number of hydrogen atoms pulled from a butyl rubber chain will be too low. Conversely, if the amount added is too high, there is a possibility that a backbone of the butyl rubber will decompose, greatly reducing a molecular weight thereof.

In the present invention, adding the radical polymeric monomer (c) with at least difunctionality will cause a reaction with the modified butyl rubber, and a cross-linking reaction will occur during peroxide cross-linking. The radical polymeric monomer (c) with at least difunctionality is not particularly limited, but examples include ethylene di(meth)acrylate (hereinafter the term “ethylene di(meth)acrylate” refers to both ethylene dimethacrylate and ethylene diacrylate); trimethylolpropane tri(meth)acrylate; ethylene glycol di(meth)acrylate; polyethylene glycol di(meth)acrylate; 1,6-hexanediol di(meth)acrylate; tetramethylolmethane tri(meth)acrylate; tetramethylolmethane tetra(meth)acrylate; tris(2-hydroxyethyl)isocyanurate tri(meth)acrylate; ethoxylated trimethylolpropane tri(meth)acrylate; pentaerythritol tri(meth)acrylate; propoxylated trimethylolpropane(meth)acrylate; propoxylated glyceryl(meth)acrylate; pentaerythritol tetra(meth)acrylate; ditrimethylolpropane tetra(meth)acrylate; dipentaerythritol penta(meth)acrylate; ethoxylated pentaerythritol tetra(meth)acrylate; polysiloxane di(meth)acrylate; urethane(meth)acrylates; metal(meth)acrylates; polypropylene glycol di(meth)acrylate; N,N′-phenylene dimaleimide; bismaleimide diphenylmethane; N,N′-phenylene diacrylamide; divinylbenzene; triallyl isocyanurate; and the like.

Of these, monomers that have an electron acceptor group in the molecule such as a carbonyl group (ketones, aldehydes, esters, carboxylates, carboxylate salts, or amides), a nitro group, a cyano group, and the like are preferable from a perspective of increasing the degree of modification.

An added amount of the monomer (c) is not particularly limited, but is preferably from 0.001 to 0.5 mol, and more preferably from 0.005 to 0.2 mol, per 100 g of the butyl rubber. If the added amount of the monomer (c) is too small, there is a possibility that cross-linking of the modified butyl rubber will not proceed. Conversely, if the added amount is too large, physical properties of the cross-linked product are liable to be inferior.

With the present invention, the modified butyl rubber (1) can be prepared by simultaneously reacting a radical polymeric monomer (d) having an alkoxysilyl group (hereinafter also referred to as “monomer (d)”) and the radical polymeric monomer (c) with at least difunctionality to produce the modified butyl rubber composition (A). Furthermore, the modified butyl rubber composition (B) can be made by simultaneously adding the monomer (c) and the monomer (d) to the modified butyl rubber (2). By simultaneously reacting or adding the monomer (c) and the monomer (d), a modulus and a breaking strength of the cross-linked rubber molded body can be increased. Therefore, durability of the molded body is increased.

The radical polymeric monomer having an alkoxysilyl group (d) is preferably as described by the following formula (14).

Si(OR⁷)₄₋ₙ(R⁶-A)ₙ (14)

(in formula (14), R⁶ and R⁷ independently are hydrocarbon groups; A represents a radical polymeric group; and n is an integer from 1 to 3.)

Herein, when n is 2 or 3, the R⁶ groups may each be a different group. Preferable examples of such R⁶ groups include alkyl groups such as methyl groups, ethyl groups, propyl groups, hexyl groups, dodecyl groups, octadecyl groups, and the like; cycloalkyl groups such as cyclopropyl groups, cyclohexyl groups, and the like; allyl groups such as phenyl groups, benzyl groups, and the like; and the like.

Also, when n is 1 or 2, the R⁷ groups may each be a different group. Preferable examples of such R⁷ groups include alkyl groups such as methyl groups, ethyl groups, propyl groups, hexyl groups, dodecyl groups, octadecyl groups, and the like; cycloalkyl groups such as cyclopropyl groups, cyclohexyl groups, and the like; allyl groups such as phenyl groups, benzyl groups, and the like; and the like.

Also, when n is 2 or 3, the radical polymeric groups A may each be a different group. Preferable examples of such radical polymeric groups A include vinyl groups, allyl groups, stearyl groups, (meth)acryloxy groups, (meth)acrylamide groups, halogenated vinyl groups, acrylonitrile groups; and the like. Of these groups, those that contain an electron-withdrawing group (such as carbonyl groups, halogen, cyano groups, or the like) are more preferable. Of these groups, (meth)acryloxy groups are especially preferable.

Preferable examples of the radical polymeric monomer (d) having an alkoxysilyl group include vinyl methoxysilane, vinyl trimethoxysilane, vinyl ethoxysilane, vinyl triethoxysilane, γ-methacryloxypropyl trimethoxysilane, γ-methacryloxypropyl methyldimethoxysilane, γ-methacryloxypropyl dimethylmethoxysilane, γ-acryloxypropylmethyl diethoxysilane, γ-acryloxypropyl dimethylethoxysilane, γ-acryloxypropyl triethoxysilane, N-(propyltriethoxysilane)maleimide, and the like.

Furthermore, the monomer (d) may be used in a hydrolyzed and condensed form. For example, a silicone oil-based coupling agent, having two or more repeating siloxane bonds and an alkoxysilyl group, that is an oligomer having a radical polymeric group, and the like may also be used.

An added amount of the monomer (d) used in the present invention is not particularly limited, but is preferably from 0.0001 to 0.5 mol, and more preferably from 0.0003 to 0.2 mol, per 100 g of the butyl rubber. If the added amount of the monomer (d) is too small, the effect of increasing the modulus and the breaking strength of the cross-linked rubber molded body will not be achieved. Conversely, if the amount of the monomer (d) is too high, there is a possibility that an excess of the monomer (d) will have a detrimental effect on a compression set of the cross-linked rubber molded body, and therefore this is not preferable.

With the present invention, the modified butyl rubber can be prepared as shown below.

The modified butyl rubber (2) is prepared by heating a pre-blended mixture of the butyl rubber, the compound (a) and the radical initiator (b) at a temperature from 150 to 220° C. in a nitrogen-substituted sealed kneader until it reacts.

The modified butyl rubber (1) is prepared by temporarily reducing the temperature, then adding the monomer (c) or the monomers (c) and (d) to the modified butyl rubber (2), repeating nitrogen substitution, and then heating at a temperature preferably from 120 to 220° C. until reaction occurs. By performing successive reactions, a degree of grafting of the monomers (c) and (d) to the butyl rubber can be increased. The aforementioned reactions are preferably performed after the nitrogen substitution, but the reactions can also be performed under oxygen-lean conditions.

Furthermore, by adding the monomer (c) or the monomers (c) and (d) to the modified butyl rubber (2), the modified butyl rubber composition (B) containing the unreacted monomers (c) and (d) may be prepared.

With the present invention, the adding and reacting of the monomers (c) and (d) can be performed by any commonly known method. Various types of additives, reinforcing fillers, and cross-linking agents may also be simultaneously added. The aforementioned modification reactions and formulation blendings can be performed using a sealed kneader, a twin-screw extrusion kneader, a single-screw extrusion kneader, a roller, a Banbury mixer, kneader, and the like.

With the present invention, the rubber composition is prepared by adding the organic peroxide to the aforementioned modified butyl rubber compositions (A) and (B), and the uncross-linked rubber molded body is molded using this rubber composition. Examples of the organic peroxide include benzoylperoxide; t-butylperoxybenzoate, dicumylperoxide; t-butylcumylperoxid; di-t-butylperoxide; 2,5-dimethyl-2,5-di-t-butylperoxyhexane; 2,5-dimethyl-2,5-di-t-butylperoxy-3-hexene; 2,4-dichlorobenzoylperoxide; di-t-butylperoxy-di-isopropylbenzene; 1,1-bis(t-butylperoxy)-3,3,5-trimethyl-cyclohexane; n-butyl-4,4-bis(t-butylperoxy)valerate; 2,2-bis(t-butylperoxy)butane; and the like.

An added amount of the organic peroxide is preferably from 0.05 to 15 parts by weight, and more preferably from 0.1 to 10 parts by weight, per 100 weight parts of the rubber composition containing the modified butyl rubber (1) and (2).

With the present invention, the modified butyl rubber compositions (A) and (B) can also contain other rubber components in addition to the modified butyl rubbers (1) and (2). Examples of such other rubber components include natural rubber, isoprene rubber, butadiene rubbers, styrene-butadiene rubbers, butyl rubber, halogenated butyl rubber, chloroprene rubber, acryl rubber, silicone rubber, fluorine rubber, epichlorohydrin rubber, a styrene-isoprene-butadiene copolymer, an ethylene-propylene-diene three-component copolymer, an ethylene-propylene copolymer, an ethylene-propylene-butene three-component copolymer, a styrene-butadiene-styrene block copolymer, a styrene-isoprene-styrene copolymer, a styrene-ethylene-butene-styrene block copolymer, a styrene-ethylene-propylene-styrene copolymer, a acrylonitrile-butadiene copolymer, a hydrogenated acrylonitrile-butadiene copolymer, polyisobutylene, polybutene, a styrene-p-methylstyrene copolymer, a halogenated styrene-p-methylstyrene copolymer, and the like. An added amount of the modified butyl rubbers (1) and (2) is preferably at least 5 weight %, more preferably at least 10 weight %, and even more preferably from 30 to 100 weight %.

The modified butyl rubber compositions (A) and (B) can also contain various additives that are generally added to rubber compositions such as carbon black, silica, talc, reinforcing agents/fillers such as clay, vulcanizing or cross-linking agents, vulcanizing or cross-linking accelerators, oils, antiaging agents, plasticizers, and the like. These additives are kneaded in by any commonly known method to form a composition, which can be used for vulcanizing or cross-linking. Added amounts of these additives may be conventional standard amounts, so long as the objectives of the present invention are not hindered.

With the manufacturing method of the present invention, the siloxane compound having a (meth)acryloyl group is applied to the surface of the uncross-linked rubber molded body formed using the rubber composition made by blending the modified butyl rubber composition (A) or (B) with the organic peroxide, and then heat-treating. The (meth)acryloyl group can be at least one group selected from an acryloyl group and a methacryloyl group. The siloxane compound having a (meth)acryloyl group can be at least one type of organopolysiloxane compound selected from those described in the following formulas (1), (2), and (3).

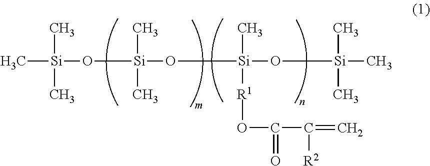

(in formula (1), R¹ is a divalent polyalkylene glycol group, a poly(oxyalkylene) group, an alkyl group, or an alkylene group; R² is hydrogen or a methyl group; and m and n are integers such that a number average molecular weight is from 1,000 to 20,000, and a ratio m:n is between 98:2 and 90:10.)

The number average molecular weight of the siloxane compound having a (meth)acryloyl group represented by formula (1) is from 1,000 to 20, 000, and preferably from 5,000 to 20,000. m and n are integers selected such that the number average molecular weight falls within the above range, and a ratio of m:n must be from 98:2 to 90:10 and preferably from 97:3 to 94:6. A number of carbon atoms in R¹ is preferably from 4 to 30 and more preferably from 8 to 18. With the present invention, a number average molecular weight of a polysiloxane compound is calculated as standard polystyrene measured by gel permeation chromatography.

An example of such a siloxane compound having a (meth)acryloyl group is an organic-modified silicone acrylate TEGO RAD 2700 manufactured by DeGussa.

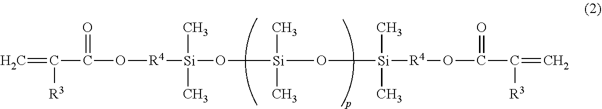

(in formula (2), R³ is hydrogen or a methyl group; R⁴ is an alkyl group or an alkylene group; and p is an integer such that a number average molecular weight is from 100 to 20,000.)

The number average molecular weight of the siloxane compound having a (meth)acryloyl group represented by the formula (2) is from 100 to 20,000 and preferably from 1,000 to 12,000. p is an integer such that the number average molecular weight falls within the above range. A number of carbon atoms in R⁴ is preferably from 1 to 30 and more preferably from 3 to 18.

Examples of such a siloxane compound having a (meth)acryloyl group include a modified silicone oil X-22-164A (manufactured by Shinetsu Chemical Co., Ltd.), double terminated Silaprene (manufactured by Chisso Corp), and the like.

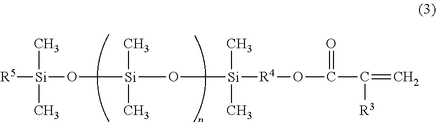

(in formula (3), R³ is hydrogen or a methyl group; R⁴ and R⁵ are indivdually alkyl groups or alkylene groups; and p is an integer such that a number average molecular weight is from 100 to 20,000.)

The number average molecular weight of the siloxane compound having a (meth)acryloyl group represented by formula (3) is from 100 to 20,000 and preferably from 1,000 to 12,000. p is an integer such that the number average molecular weight falls within the above range. Furthermore, preferably a number of carbon atoms in R⁴ and R⁵ is independently from 1 to 30, and more preferably from 3 to 18, respectively.

Examples of such a siloxane compound having a (meth)acryloyl group include modified silicone oil X-22-2426 (manufactured by Shinetsu Chemical Co., Ltd.), single terminated Silaprene (manufactured by Chisso Corp.), and the like.

Since the manufacturing method of the surface-modified rubber molded body of the present invention includes forming the uncross-linked rubber molded body using the rubber composition containing the organic peroxide and the aforementioned modified butyl rubber compositions (A) or (B), applying the siloxane compound having a (meth)acryloyl group to the surface of the uncross-linked rubber molded body, and then heat-treating, the peroxide cross-linking of the uncross-linked rubber molded body and the reaction of the siloxane compound having a (meth)acryloyl group will occur simultaneously. Thus, the siloxane compound will firmly bond to the surface of the rubber molded body, making it possible to obtain a surface-modified rubber molded body with excellent release properties and slip properties, and greatly enhanced sustainability of release performance.

This surface-modified rubber molded body is suitable for use as a bladder that is used in a vulcanization molder for a pneumatic tire. By using such a bladder, excellent release properties and slip properties can be obtained without applying various types of release agents such as those of silicone and the like to an outer surface of the bladder or an inner surface of an unvulcanized tire. Furthermore, this excellent release performance can be sustained for a long period of time, almost the entire life of the bladder.

The present invention is further explained below by examples. However, the scope of the present invention is not limited to these examples.

### EXAMPLES

Three types of rubber compositions (Compositions 1 through 3) with formulations shown in Table 1 were prepared by kneading for 6 minutes in a 150 cc kneader, and then kneading using an 8 inch open roller. Uncross-linked rubber molded bodies were fabricated by pressing the three types of rubber compositions obtained at 90° C. to form 6 inch×6 inch sheets.

Using the uncross-linked rubber molded body obtained, a siloxane compound having a (meth)acryloyl group (shown as “surface treatment” in the table) was applied to a surface of the uncross-linked rubber molded body, based on the combinations shown in Table 2. Then, heat-treating was performed according to the conditions shown in Table 2 to obtain 8 types of rubber molded bodies (Examples 1 through 4 and Comparative Examples 1 through 4). With Comparative Examples 1 through 4, the siloxane compound having a (meth)acryloyl group was not applied.

A surface-treated surface of the 8 types of rubber molded bodies obtained was sufficiently washed using methylethyl ketone and xylene to remove the unreacted siloxane compound. An unvulcanized rubber sheet (thickness 2 mm) made from a rubber composition used for inner liners with a formulation shown in Table 3 was overlaid on the surface-treated surface and then press vulcanization was performed for 10 minutes at 180° C. The release properties when the obtained vulcanized rubber sheet for an inner liner was peeled by hand from the surface-treated rubber molded body were evaluated according to the following criteria.
∘: Complete and easy peeling was possible.
Δ: Peeling was easy, but there was slight resistance at the edges of the sheet.
×: Peeling by hand was not possible because of adhesion.

TABLE 1

| | | Comp. 1 | Comp. 2 | Comp. 3 |
|---|---|---|---|---|
| IIR | Parts by wt. | 100 | | |
| Modified IIR (1) | Parts by wt. | | 100 | |
| Modified IIR (2) | Parts by wt. | | | 100 |
| CR | Parts by wt. | 5 | | |
| Carbon black | Parts by wt. | 50 | 50 | 50 |
| Stearic acid | Parts by wt. | | 1 | 1 |
| Oil | Parts by wt. | 5 | 5 | 5 |
| Zinc oxide | Parts by wt. | 5 | 5 | 5 |
| Cross-linking resin | Parts by wt. | 10 | | |
| Organic peroxide | Parts by wt. | | 3 | 3 |
| Monomer (c) | Parts by wt. | | | 5 |

Notes to Table 1:
The abbreviations used in the column headings are as followings: “Comp.” is an abbreviation of “Composition”.

Raw materials used in Table 1 are shown below. IIR: Butyl rubber, BUTYL 301 (manufactured by Lanxess K. K.)
Modified IIR (1): Modified butyl rubber (1), manufactured by the method shown below.
Modified IIR (2): Modified butyl rubber (2), manufactured by the method shown below.
CR: Chloroprene rubber, Neoprene W (manufactured by DuPont)
Carbon Black: HAF grade carbon black (manufactured by Tokai Carbon Co., Ltd.)
Stearic acid: Beads Stearic Acid YR (manufactured by NOF Corp.)
Oil: Castor bean oil, Castor Oil (manufactured by Ito Oil Chemicals Co., Ltd.)
Zinc oxide: Zinc Oxide #3 (manufactured by Seido Chemical Industry Co., Ltd.)
Cross-linking resin: Alkyl phenol-formaldehyde resin, Hitanol 2501Y (manufactured by Hitachi Chemical Co., Ltd.)
Organic peroxide: Dicumyl peroxide, Percumyl D-40 (manufactured by NOF Corp.)
Monomer (c): Ditrimethylol propane tetraacrylate, SR-355 (manufactured by Sartomer)

### Preparation of Modified Butyl Rubber (1)

350.0 g of butyl rubber (BUTYL 301 manufactured by Lanxess Co., Ltd.), 32.2 g of OH-TEMPO (4-hydroxy-2,2,6,6-tetramethylpiperidinyl-1-oxyl, LA7RD manufactured by ADEKA Corp., compound (a)), and 24.2 g of 1,3-bis-(t-butyl peroxyisopropyl)benzene (Percadox 14-G manufactured by Kayaku Akzo Co., Ltd., radical initiator (b)) were weighed into a sealed Banbury mixer set to a temperature of 60° C. and blended for 10 minutes. The mixture obtained was kneaded in a sealed Banbury mixer set to a temperature of 100° C. while performing nitrogen substitution for 5 minutes. While kneading, the temperature was increased to 165° C. and kneading was continued for 20 minutes. A portion of the polymer obtained was dissolved in toluene, and the polymer was isolation purified by reprecipitation action. A TEMPO position of introduction (of the alkoxyamino group) was confirmed by analyzing with ¹H-NMR using the purified product. A degree of introduction thereof was 0.360 mol %.

The reaction system was temporarily brought to 150° C., and then 11.2 g of ditrimethylol propane tetraacrylate (SR-355 manufactured by Sartomer, monomer (c)) and 5.8 g of methacrylsilane (gamma-methacryloxypropyl trimethoxysilane, KBM503 manufactured by Shin-Etsu Chemical Co., Ltd., monomer (d)) were weighed and added. Then, nitrogen substitution was performed for 5 minutes while kneading. While kneading, the temperature was increased to 185° C. and kneading was continued for 15 minutes to obtain the modified butyl rubber (1).

A portion of the modified butyl rubber (1) obtained was dissolved in toluene, and the polymer was isolation purified by reprecipitation action. IR analysis and ¹H-NMR analysis were performed using the purified product. Ester carbonyl absorption was observed around 1,720 cm⁻¹, and a ditrimethylol propane signal was observed near 6.39, 6.10, 5.96, 4.12, and 3.30 ppm according to the ¹H-NMR. It was confirmed that the ditrimethylol propane tetraacrylate was introduced with a structure that left three olefins remaining. A degree of introduction thereof was 0.084 mol %. Furthermore, a methacrylsilane signal was observed near 3.55 ppm, and a degree of introduction thereof was 0.015 mol %.

### Preparation of the Modified Butyl Rubber (2)

350.0 g of butyl rubber (BUTYL 301 manufactured by Lanxess Co., Ltd.), 32.2 g of OH-TEMPO (4-hydroxy-2,2,6,6-tetramethylpiperidinyl-1-oxyl, LAIRD manufactured by ADEKA Corp., compound (a)), and 30.4 g of di-t-butyl peroxide (Perbutyl D manufactured by NOF Corp., radical initiator (b)) were weighed into a sealed Banbury mixer set to a temperature of 60° C. and blended for 10 minutes. The mixture obtained was kneaded in a sealed Banbury mixer set to a temperature of 100° C. while performing nitrogen substitution for 5 minutes. While kneading, the temperature was increased to 186° C. and kneading was continued for 20 minutes to obtain the modified butyl rubber (2).

A portion of the modified butyl rubber (2) obtained was dissolved in toluene, and the polymer was isolation purified by reprecipitation action. A TEMPO position of introduction (of the alkoxyamino group) was confirmed by analyzing with ¹H-NMR using the purified product. A degree of introduction thereof was 0.348 mol %.

TABLE 2

| | | CE 1 | CE 2 | CE 3 | CE 4 | Ex 1 | Ex 2 | Ex 3 | Ex 4 |
|---|---|---|---|---|---|---|---|---|---|
| Rubber | Type of rubber | Comp. 1 | Comp. 1 | Comp. 1 | Comp. 2 | Comp. 2 | Comp. 2 | Comp. 3 | Comp. 3 |
| molded | composition | | | | | | | | |
| body | Surface-treated? | No | Yes | Yes | No | Yes | Yes | Yes | Yes |
| | Type of surface | — | CPD | CPD | — | CPD | CPD | CPD | CPD |
| | treatment | | A | B | | A | B | A | B |
| | Heating | 198 | 198 | 198 | 180 | 180 | 180 | 180 | 180 |
| | temperature (° C.) | | | | | | | | |
| | Heating time (min) | 30 | 30 | 30 | 20 | 20 | 20 | 20 | 20 |

| | | | | | | | | |
|---|---|---|---|---|---|---|---|---|
| Evaluation of release | X | X | X | X | Δ | ◯ | Δ | ◯ |
| properties | | | | | | | | |

Notes to Table 2:
The abbreviations used in the column headings are as followings: “CE” is an abbreviation of “Comparative Example”, “Ex” is an abbreviation of “Example”, “Comp.” is an abbreviation of “Composition”, and “CPD” is an abbreviation of “Compound”.

The types of raw materials used in Table 2 are shown below.
Compositions 1 through 3: Rubber compositions as shown in Table 1
Compound A: Siloxane compound having a (meth)acryloyl group represented by Chemical Formula (2), number average molecular weight of 1,720, modified silicone oil X-22-164A (manufactured by Shin-Etsu Chemical Co., Ltd.)
Compound B: Siloxane compound having a (meth)acryloyl group represented by Chemical Formula (1), number average molecular weight of 20,000, organic modified silicone acrylate TEGO RAD 2700 (manufactured by Degussa)

TABLE 3

| | | |
|---|---|---|
| IIR | Parts by wt. | 100 |
| Carbon black | Parts by wt. | 60 |
| Stearic acid | Parts by wt. | 2 |
| Oil | Parts by wt. | 8 |
| Zinc oxide | Parts by wt. | 3 |
| Magnesium oxide | Parts by wt. | 0.5 |
| Petroleum resin | Parts by wt. | 3 |
| Sulfur | Parts by wt. | 0.5 |
| Vulcanization | Parts by wt. | 1.5 |
| accelerator | | |

The types of raw materials used in Table 3 are shown below.
IIR: Butyl rubber, BUTYL 301 (manufactured by Lanxess Co., Ltd.)
Carbon Black: GPF grade carbon black manufactured by Tokai Carbon Co., Ltd.
Stearic acid: Beads Stearic Acid YR (manufactured by NOF Corp.)
Oil: Aromatic oil FR-120 (manufactured by Air Water Inc.)
Zinc oxide: Zinc Oxide #3 (manufactured by Seido Chemical Industry Co., Ltd.)
Magnesium oxide: Kyomag 150 (manufactured by Kyowa Chemical Corp.)
Petroleum resin: Hilets G100X (manufactured by Mitsui Chemicals, Inc.)
Sulfur: Powdered sulfur (manufactured by Karuizawa Seisakusho Co., Ltd.)
Vulcanization accelerator: MBTS, Nocceler DM (manufactured by Ouchi Shinko Chemical Industrial Co., Ltd.)

The rubber composition for an inner liner in Table 3 was made by measuring the formulation components other than sulfur and the vulcanization accelerator, kneading in a sealed Banbury mixer, discharging a master batch at a temperature of 160° C., and cooling to room temperature. Sulfur and the vulcanization accelerator were then added to the master batch in a sealed Banbury mixer to produce the rubber composition.

1. A manufacturing method for a surface-modified rubber molded body, comprising the steps of
forming an uncross-linked rubber molded body made from a rubber composition comprising an organic peroxide and
a modified butyl rubber composition (A) comprising a modified butyl rubber (1) where a compound (a) having a stable nitroxide free radical in a molecule at an ambient temperature in the presence of oxygen, a radical initiator (b), and a radical polymeric monomer (c) having at least difunctionality are reacted with a butyl rubber, or a modified butyl rubber composition (B) where the monomer (c) is added to a modified butyl rubber (2) where the compound (a) and the radical initiator (b) are reacted with a butyl rubber;
applying a siloxane compound having a (meth)acryloyl group onto a surface of the uncross-linked rubber molded body; and
heat-treating.

2. The manufacturing method for a surface-modified rubber molded body according to claim 1, wherein the siloxane compound having a (meth)acryloyl group is at least one type selected from organopolysiloxane compounds represented by the following formulas (1), (2), or (3); 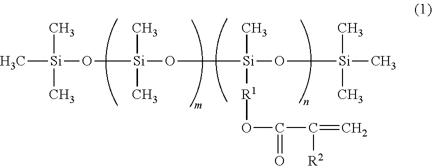
(wherein, R¹ is a divalent polyalkylene glycol group, a poly(oxyalkylene) group, an alkyl group, or an alkylene group; R² is hydrogen or a methyl group; and m and n are integers selected such that a number average molecular weight is from 1,000 to 20,000 and a ratio m:n is from 98:2 to 90:10); 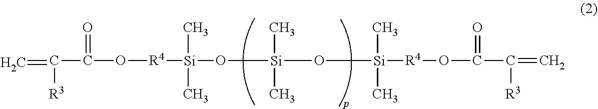
(wherein, R³ is a hydrogen or a methyl group; R⁴ is an alkyl group or an alkylene group; and p is an integer selected such that a number average molecular weight is from 100 to 20,000); and 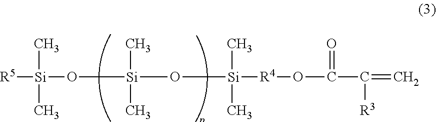
(wherein, R³ is hydrogen or a methyl group; R⁴ and R⁵ independently are alkyl groups or alkylene groups; and p is an integer selected such that a number average molecular weight is from 100 to 20,000).

3. The manufacturing method for a surface-modified rubber molded body according to claim 1, wherein
the radical polymeric monomer (c) having at least difunctionality and a radical polymeric monomer (d) having an alkoxysilyl group are simultaneously reacted or compounded.

4. The manufacturing method for a surface-modified rubber molded body according to claim 1, wherein the rubber molded body is a bladder that is used in a vulcanization molder for a pneumatic tire.

5. The manufacturing method for a surface-modified rubber molded body according to claim 2, wherein
the radical polymeric monomer (c) having at least difunctionality and a radical polymeric monomer (d) having an alkoxysilyl group are simultaneously reacted or compounded.

6. The manufacturing method for a surface-modified rubber molded body according to claim 2, wherein the rubber molded body is a bladder that is used in a vulcanization molder for a pneumatic tire.

7. The manufacturing method for a surface-modified rubber molded body according to claim 1, wherein compound (a) comprises from 0.001 to 0.5 mol per 100 g of the butyl rubber.

8. The manufacturing method for a surface-modified rubber molded body according to claim 7, wherein compound (a) comprises from 0.005 to 0.1 mol per 100 g of the butyl rubber.

9. The manufacturing method for a surface-modified rubber molded body according to claim 1, wherein the radical polymeric monomer (d) comprises from 0.0001 to 0.5 mol per 100 g of the butyl rubber.

10. The manufacturing method for a surface-modified rubber molded body according to claim 9, wherein the radical polymeric monomer (d) comprises from 0.0003 to 0.2 mol per 100 g of the butyl rubber.

11. The manufacturing method for a surface-modified rubber molded body according to claim 1, wherein the organic peroxide comprises from 0.05 to 15 parts by weight per 100 weight parts of the modified butyl rubber (1) and (2).

12. The manufacturing method for a surface-modified rubber molded body according to claim 11, wherein the organic peroxide comprises from 0.1 to 10 parts by weight per 100 weight parts of the modified butyl rubbers (1) and (2).

13. The manufacturing method for a surface-modified rubber molded body according to claim 1, wherein an amount of the modified butyl rubbers (1) and (2) comprises at least 5 weight %.

14. The manufacturing method for a surface-modified rubber molded body according to claim 13, wherein an amount of the modified butyl rubbers (1) and (2) comprises at least 10 weight %.

15. The manufacturing method for a surface-modified rubber molded body according to claim 14, wherein an amount of the modified butyl rubbers (1) and (2) comprises from 30 to 100 weight %.

16. The manufacturing method for a surface-modified rubber molded body according to claim 2, wherein the number average molecular weight of the compound of formula (1) is from 5,000 to 20,000 and the ratio m:n is from 97:3 to 94:6.

17. The manufacturing method for a surface-modified rubber molded body according to claim 2, wherein R¹ comprises from 4 to 30 carbon atoms.

18. The manufacturing method for a surface-modified rubber molded body according to claim 17, wherein R¹ comprises from 8 to 18 carbon atoms.

19. The manufacturing method for a surface-modified rubber molded body according to claim 2, wherein the number average molecular weight of the compound of formula (2) is from 1,000 to 12,000.

20. The manufacturing method for a surface-modified rubber molded body according to claim 2, wherein R⁴ comprises from 1 to 30 carbon atoms.
